(19) United States
(12) Patent Application Publication
(10) Pub. No.: US 2026/0155143 A1
(43) Pub. Date: Jun. 4, 2026

(54) CONTROL OF A VIRTUAL ASSISTANT AMONG LISTENING DEVICES

(71) Applicant: Motorola Mobility LLC, Chicago, IL (US)

(72) Inventors: Amit Kumar Agrawal, Bangalore (IN); Krishnan Raghavan, Bangalore (IN); Nakul Patel, Bangalore (IN)

(73) Assignee: Motorola Mobility LLC, Chicago, IL (US)

(21) Appl. No.: 18/965,480

(22) Filed: Dec. 2, 2024

(51) Int. Cl. G10L 15/22; G10L 15/06; G10L 15/18

(52) U.S. Cl. CPC G10L 15/22; G10L 15/063; G10L 15/18; G10L 2015/223

(57) ABSTRACT

In aspects of controlling a virtual assistant among listening devices, audio data of a conversation is captured via a microphone of an electronic device. Based on determining that the user does not intend to utilize a virtual assistant of the electronic device, the virtual assistant ignores the conversation. For example, the electronic device determines that the user does not intend to utilize the virtual assistant based on the user's engagement with another electronic device. In other scenarios, the user's intention is determined based on the proximity of the user, the conversation including another person, or a classification of the conversation using a machine-learning model based on emotional cues, keywords, tone, or speaking volume.

### BACKGROUND

With the advancement of technology, electronic devices with personal voice assistants have become a common part of our daily lives. For example, many people carry cell phones and smartwatches with personal voice assistants throughout the day. Similarly, many homes include devices (e.g., smart speakers) with personal voice assistants that have become integral to daily routines, offering hands-free convenience and seamless integration with other smart home devices. These voice-activated services help users control appliances, set reminders, play music, and answer complex questions with simple commands.

### BRIEF DESCRIPTION OF THE DRAWINGS

Aspects of controlling a virtual assistant among listening devices are described with reference to the following Figures. The same numbers may be used throughout to reference similar features and components shown in the Figures. Further, identical numbers followed by different letters reference different instances of features and components described herein:

FIG. 1 illustrates an example environment in which aspects of controlling a virtual assistant among listening devices can be implemented;

FIG. 2 depicts an example system in which aspects of controlling a virtual assistant among listening devices can be implemented;

FIG. 3 depicts an example flow diagram in which aspects of controlling a virtual assistant among listening devices can be implemented;

FIG. 4 depicts an example procedure for controlling a virtual assistant among listening devices in accordance with one or more implementations; and

FIG. 5 illustrates various components of an example electronic device that can implement embodiments of the techniques described herein.

### DETAILED DESCRIPTION

Control of a virtual assistant among listening devices is discussed herein. Personal voice assistants have become ubiquitous in many users'lives. For example, personal voice assistants are commonly found in smartphones, smart watches, automotive entertainment systems, and home speakers. These assistants have become integral to daily routines by offering hands-free convenience and seamless integration with other devices.

As large language models (LLMs) and action models improve and evolve, new use cases are continually emerging for voice assistants to make them smarter and more versatile. These advancements increase adoption rates as users discover more ways to incorporate voice technology. As a result, voice assistants have advanced from novelty items for relatively few users to essential tools for many users to improve convenience, efficiency, and connectivity in the modern world.

This growing reliance on voice assistants, often designed to listen continually, brings both convenience and new challenges. For example, unintended capturing of conversations can update an assistant's memory or user profile with incorrect or irrelevant information, leading to potential confusion or unintended disclosures later. An assistant system might mistakenly update a shopping list by detecting an intent to purchase a particular product mentioned during a phone call on a different device and storing it without context. “Ghosting,” where assistants activate without a keyword inadvertently or by design, is common and can lead to accidental data capture. As the associated technology advances, voice assistants may evolve to no longer utilize explicit activation commands, further intensifying these issues. Unintended capture can cause embarrassment or expose surprises and sensitive information to unintended audiences. In addition, it is important for many users to manage and minimize these risks to maintain both convenience and privacy.

One conventional technique addresses these privacy issues by using proximity sensors and context-aware mechanisms to determine when a voice assistant should record conversations, allowing user-defined privacy preferences. However, this conventional technique relies on user-defined rules and does not provide a mechanism to differentiate between relevant commands and regular conversations to determine the user's intent in real-time.

In contrast, the described techniques and systems for controlling a virtual assistant among listening devices (e.g. nearby devices) avoid these common issues. For instance, an electronic device uses an always-on microphone to build a personal knowledge base (PKB) associated with one or more users based on detecting and listening to the user's conversations in the environment. When new voice activity (e.g., a conversation) is detected, the electronic device monitors the user's activity to determine if the user is using another device, is nearby, or is speaking to another person. In particular, the electronic device determines if the user is actively engaged on a second device unrelated to the electronic device (e.g., communicating to or on a different device) using a connected device monitoring solution. The electronic device also determines if the user is within a predefined proximity of the electronic device. For example, background conversations can be eliminated or ignored using techniques such as sound strength sensors or internet-of-things (IoT)-based proximity detection. The electronic device can also determine if the user is speaking to someone else (e.g., using techniques such as speaker diarization to partition audio and identify different speakers).

The electronic device analyzes the captured audio to determine the user intent and whether the user is speaking to the first electronic device using natural language processing and/or context recognition techniques to differentiate between triggering intents (e.g., direct commands, questions, etc.) and irrelevant conversations (e.g., personal discussions). In addition to intent and context, the electronic device can also analyze tones and emotional cues to enhance understanding. In response to determining that the user is engaged in an irrelevant conversation, the electronic device prevents feeding the audio input to the voice assistant system unless specifically instructed otherwise.

While features and concepts of the described techniques for controlling a virtual assistant among listening devices can be implemented in any number of different devices, systems, environments, and/or configurations, implementations of the techniques and systems for controlling a virtual assistant among listening devices are described in the context of the following example devices, systems, and methods.

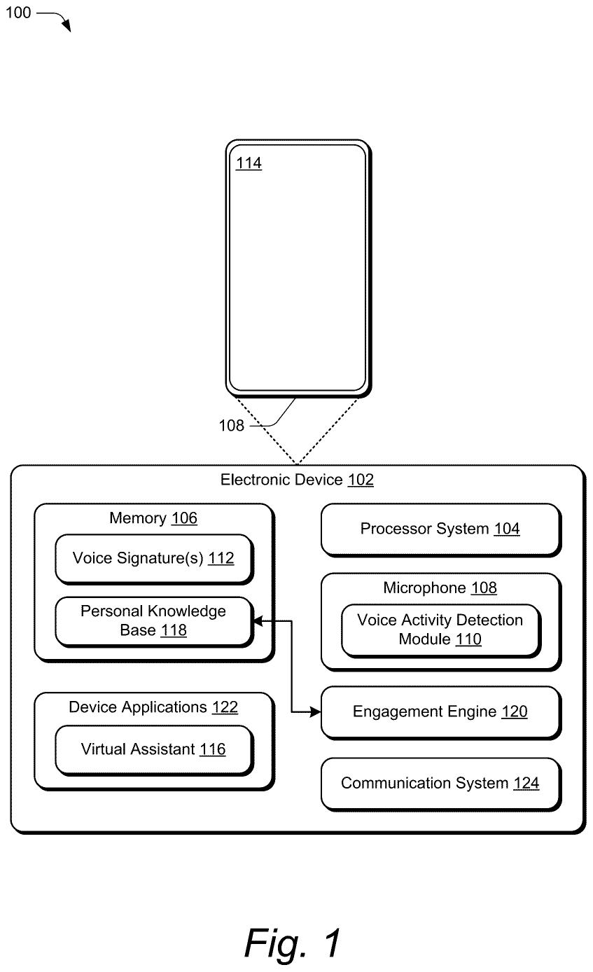

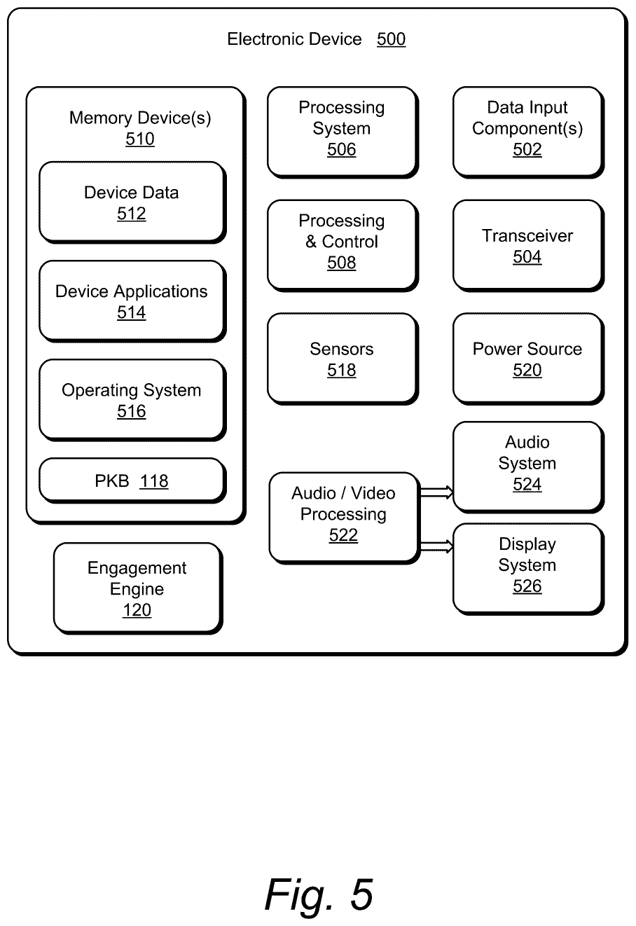

FIG. 1 illustrates an example environment 100 in which aspects of controlling a virtual assistant among listening devices can be implemented. The environment 100 includes an electronic device 102, which may be any type of mobile phone, smartphone, flip phone, computing device, tablet device, smartwatch, smart home device, smart speaker, and/or any other type of electronic device. Generally, the electronic device 102 may be any electronic, computing, and/or communication device implemented with various components, such as a processor system 104 and memory 106, as well as any number and combination of different components as further described with reference to the example device shown in FIG. 5.

The electronic device 102 includes a microphone 108, which collects audio data representing or describing a user's conversation. For example, microphone 108 includes a combination of micro-electro-mechanical systems (MEMS) microphones, such as omnidirectional microphones and/or directional microphones, to capture audio data. The electronic device 102 or microphone 108 includes a voice activity detection module 110 to determine when audio data is available (e.g., when a conversation has begun) and initiate audio data capture by microphone 108. The voice activity detection module 110 may listen for a voice signature 112 of one or more specific users before initiating data capture by the microphone 108. For example, the voice activity detection module 110 can use the voice signature 112 to authenticate or verify the user.

In one or more implementations, the microphone 108 is located near or to the side of a display 114 of the electronic device 102 (e.g., in a bevel around the display 114 of the device). As shown, the microphone 108 is illustrated as located in or near a bottom edge of the electronic device 102, however, it is to be appreciated that the size, shape, and location of a cutout associated with the microphone 108 can vary. It is to be appreciated that the microphone 108 can be any type of microphone array, including but not limited to electret condenser microphones, dynamic microphones, ribbon microphones, array microphones, MEMS microphones, omnidirectional microphones, unidirectional microphones, bidirectional microphones, etc. Further, the display 114 represents functionality (e.g., hardware and logic) for enabling visual output of content by the electronic device 102 (e.g., via a user interface), and in various implementations, the display 114 is a touch-sensitive display, enabling receipt of touch inputs via the display 114.

The memory 106 is illustrated as maintaining known voice signatures 112, which is audio data associated with a user authorized to access the functionality and content of the electronic device 102, including a virtual assistant 116. Broadly, when access to secure content and/or secure functionality of the electronic device 102 is requested (e.g., a user attempts to unlock the electronic device 102 or access a secure device application), audio data is collected via the microphone 108 and compared to the known voice signatures 112. If the collected audio data matches the known voice signatures 112, then access to the requested content and/or requested functionality is granted. The voice signatures 112 include audio data associated with any number of users authorized to access the functionality and content of the electronic device 102.

The memory 106 is further illustrated as including a personal knowledge base 118, which includes user profile information that can enhance user experiences and interactions with personal voice assistants. For example, the personal knowledge base 118 includes demographic information (e.g., age, gender, location, etc.), interests and preferences (e.g., hobbies, favorite topics, preferred content formats), behavioral data (e.g., browsing history, purchase history, social media activity, past requests), feedback data (e.g., explicit or implicit feedback on products, services, or content), and/or personal knowledge (e.g., calendars, user-generated content, notes, bookmarks, etc.) for one or more users associated with the electronic device 102. In other implementations, the personal knowledge base 118 or a portion thereof (e.g., containing sensitive information) is stored in a secure element, which may be separate from the general memory of the electronic device 102. For example, the secure element can be an embedded secure element (eSE), which is a tamper-resistant hardware device, such as a smart card chip that includes its own integrated processor, memory (e.g., ROM, EEPROM, RAM), and an I/O port for tamper-proof connectivity and data communication with other hardware devices implemented in the electronic device 102.

The electronic device 102 also includes an engagement engine 120. The engagement engine 120 is software in the electronic device 102 to analyze the captured audio data to determine whether the user is speaking to the electronic device 102. For example, the engagement engine 120 uses natural language processing or context recognition techniques to differentiate between assistance-triggering intents (e.g., direct commands, questions, etc.) and irrelevant conversations (e.g., personal discussions or communications to or on another electronic device). The engagement engine 120 can also analyze tones and emotional cues to enhance understanding of the context and user's intent. Based on the determined intent, the engagement engine 120 determines whether to update the personal knowledge base 118 or ignore the conversation. The engagement engine 120 can also use predefined personal preference settings (e.g., “ignore phone conversations,” “do not record private conversations,” etc.) included in the personal knowledge base 118 associated with the user. The engagement engine 120 may also request user confirmation before updating the personal knowledge base 118 or ignoring the conversation.

The mobile device 102 also includes one or more device applications 122 and communication system(s) 124. The device applications 122 are software applications designed to exchange or send (e.g., using the communication system 124) data or instructions associated with a user's request to a receiver of another electronic device associated with the request. For example, the device applications 122 include a virtual assistant 116 that uses artificial intelligence and natural language processing to understand and respond to voice commands. For example, the virtual assistant 116 can understand and process simple to complex queries to perform tasks (e.g., set alarms, send messages, make calls, and control smart home devices), provide information (e.g., answers to questions, news updates, weather reports), and learn from user interactions to improve over time.

The communication system 124 includes communication transceivers that enable wireless communication of the data or instructions with other electronic devices. Example transceivers include wireless personal area network (WPAN) radios compliant with various IEEE 802.15 (Bluetooth™) standards, wireless radios compliant with various IEEE 802.15.4 (Ultra-Wideband™) standards wireless local area network (WLAN) radios compliant with any of the various IEEE 802.11 (WiFi™) standards, wireless wide area network (WWAN) radios for cellular phone communication, wireless metropolitan area network (WMAN) radios compliant with various IEEE 802.15 (WiMAX™) standards, wired local area network (LAN) Ethernet transceivers for network data communication, and cellular networks (e.g., third generation networks, fourth generation networks such as LTE networks, or fifth generation networks).

Consider an example scenario of a conventional voice assistant system engaging with an implied request included in a user's conversation. In this scenario, a father talks with his son on a smartphone and excitedly plans a surprise gift for his wife. The father and son discuss various options for the wife's birthday and narrow the gift options down to a piece of jewelry and a designer dress from a particular shopping platform. As the conversation ends, the father mentions he will add the items to a shopping cart associated with the shopping platform and complete the purchase later. Later that day, the wife returns and opens the shopping platform to order groceries. The wife notices that the shopping cart includes jewelry and a designer dress and asks the husband about them. When asked, the husband realizes that an always-on voice assistant associated with a smart speaker had listened to his earlier conversation and automatically added the items to the shopping cart, ruining the surprise for the wife's birthday.

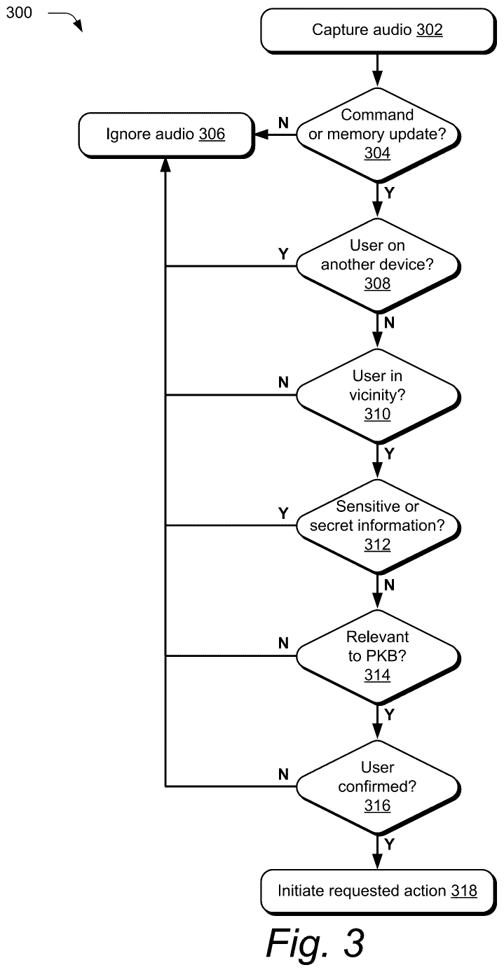

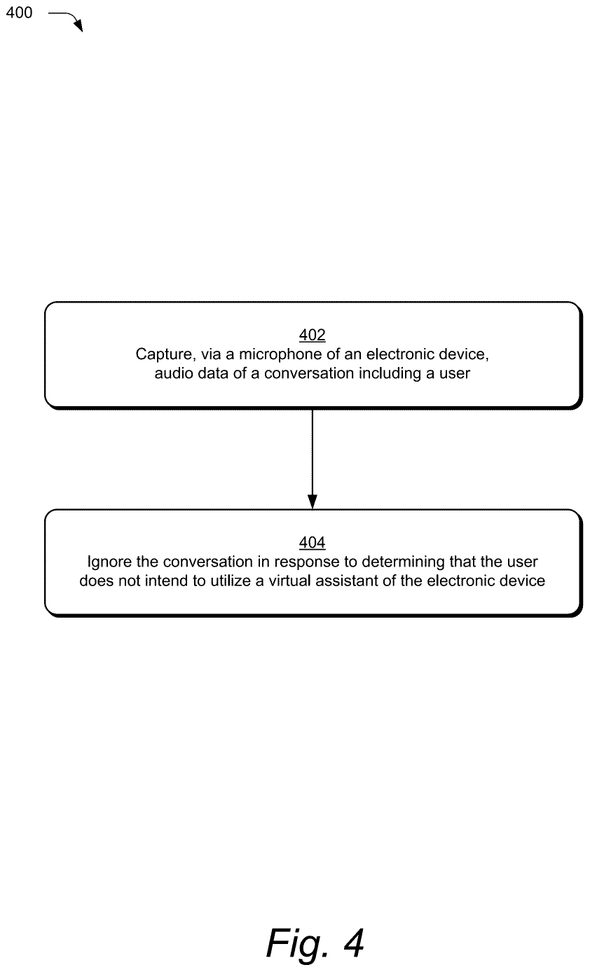

As described in greater detail with respect to FIGS. 3 and 4, the described techniques determine whether the user's conversation is directed to the electronic device 102 or intends for the virtual assistant 116 to listen to the conversation to avoid inadvertent actions, as exemplified in the above example scenario. For example, electronic device 102 determines whether the user is engaged on another electronic device or speaking with another person. If so, the electronic device 102 then ignores the conversation and does not engage in actions and updates of the personal knowledge base 118 associated with the conversation.

Having discussed an example environment in which the disclosed techniques can be performed, consider now some example scenarios and implementation details for implementing the disclosed techniques.

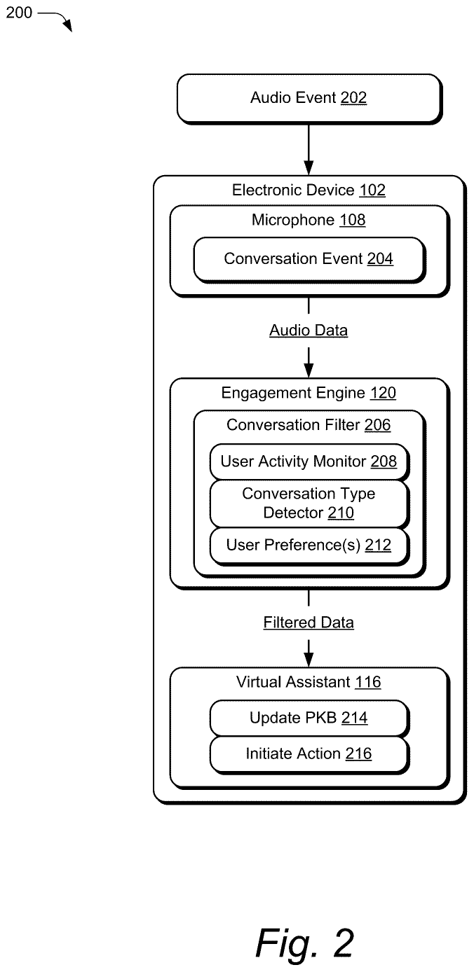

FIG. 2 depicts an example system 200 in which aspects of controlling a virtual assistant among listening devices can be implemented. By way of example, the microphone 108 receives audio data associated with one or more audio events 202. The audio event 202 can include spoken utterances or a conversation of a user of the electronic device 102 detected by the microphone 108. The audio event 202 can also include background noise (e.g., from nearby machinery or equipment), multimedia sound (e.g., a nearby radio or television), or other noise.

The microphone 108 or another component of the electronic device 102 uses the voice activity detection module 110 to determine whether the audio event 202 includes a conversation event 204. For example, the voice activity detection module 110 distinguishes between irrelevant or background noises and user conservations that may include actionable data for the virtual assistant 116. The conversation events 204 include a user of the electronic device 102 speaking to the electronic device 102, on another electronic device, or with another person. In one implementation, the voice activity detection module 110 uses a voice signature or similar biometric analysis to limit conversation events 204 to audio events 202 that include a user associated with the electronic device 102. Although conversation event 204 is described with reference to a single user, conversation event 204 can relate to multiple users of the electronic device 102.

In response to identifying a conversation event 204, the microphone 108 or voice activity detection module 110 provides the audio data to a conversation filter 206 of the engagement engine 120. The conversation filter 206 uses a user activity monitor 208, conversation type detector 210, and user preferences 212 to determine whether the user intends to utilize the virtual assistant 116 of the electronic device 102 (e.g., to update the personal knowledge base 118 or perform an action based on the conversation event 204). If it is determined that the user does not intend to utilize the virtual assistant 116, the conversation filter 206 ignores the conversation event 204. If it is determined that the user intends to utilize the virtual assistant 116, the conversation filter 206 provides the filtered data associated with the conversation event 204 to the virtual assistant 116. The filtered data can include a portion of the conversation event 204 that is actionable for the virtual assistant 116, including information to update the personal knowledge base 214 associated with the user or initiate an action 216. In other implementations, the complete audio data associated with the conversation event 204 is provided as the filtered data to the virtual assistant 116, which analyzes the filtered data to determine any personal-knowledge-base updates or action requests.

The user activity monitor 208 uses a connected device monitoring solution to determine if the user associated with the conversation event 204 is actively engaged on or using another electronic device. For example, the user activity monitor 208 determines whether the user is engaged in a phone call on a second electronic device (e.g., a work call on a laptop). The user activity monitor 208 can also use one or more sensors (e.g., sound strength or proximity sensors) to determine if the user is speaking in proximity to the electronic device 102. Similarly, the user activity monitor 208 can determine if the user is facing the electronic device 102. In response to determining that the user is engaged on a second device, not proximate, and/or not facing the electronic device 102, the conversation filter 206 generally ignores the conversation event 204 and does not provide the filtered data to the virtual assistant 116.

The conversation type detector 210 analyzes the captured audio data to determine whether the intent or context of the conversation event 204 indicates the user is speaking to the electronic device 102. For example, the conversation type detector 210 uses one or more machine-learning models with natural language processing and/or context recognition training to differentiate between assistant-triggering intents (e.g., direct commands, calendar-related information, requests, questions) and irrelevant conversations (e.g., personal discussions). Similarly, voice recognition and speaker diarization techniques can be employed to determine if the user is speaking to another individual. In another implementation, the conversation type detector 210 can analyze tones and emotional cues to enhance intent and context understanding. In response to determining that the intent or context of the conversation event does not indicate the user is speaking to the electronic device 102, the conversation filter 206 generally ignores the conversation event 204 and does not provide the filtered data to the virtual assistant 116.

In some implementations, and before ignoring the conversation event 204, the conversation filter 206 can determine whether a user preference 212 overrides the initial “ignore” determination. The user preference 212 can be an explicit preference enabled or input by the user. For example, the user may establish a user preference 212 that phone conversations on a particular electronic device (e.g., the user's laptop) or using a particular application (e.g., a videoconferencing application) should not be ignored. Similarly, the user preference 212 can be an implicit preference learned by the engagement engine 120. For example, if the engagement engine 120 utilizes a feedback loop to confirm the ignoring of a conversation event 204 and the user indicates that a particular event should not be ignored, the engagement engine 120 can explicitly or implicitly learn which aspects of that event caused the user's feedback.

FIG. 3 depicts an example flow diagram 300 in which aspects of controlling a virtual assistant among listening devices can be implemented. At 302, audio is captured by an electronic device. By way of example, the electronic device 102 or a voice activity detection module 110 captures audio data associated with a conversation sensed by the microphone 108. At 304, it is determined whether the audio includes a command or memory update. By way of example, the engagement engine 120 determines if the detected conversation includes a command, action request, or memory update (e.g., of the personal knowledge base 118) to be performed. If the microphone 108 is in an “always listening” operation mode, the engagement engine 120 determines if the conversation includes an actionable item to be performed or carried out by the virtual assistant 116. If the microphone 108 is in a “standby” operation mode, the engagement engine 120 determines if the conversation includes a trigger word or phrase to initiate the virtual assistant 116 to listen to the subsequent conversation and perform a requested action.

At 306, and in response to a command or memory update not being included in the captured audio (e.g., a “no” or “N” determination at block 304), the electronic device 102 or voice activity detection module 110 ignores the audio. The electronic device 102 or voice activity detection module 110 also resumes a previous listening mode (e.g., the “always listening” or “standby” operation modes).

At 308, it is determined whether the user or speaker is on or interacting with another electronic device. By way of example, the electronic device 102 or the engagement engine 120 determines if the user is actively using another electronic device (e.g., a smart speaker, smartphone, laptop, desktop computer, tablet, etc.) different from the electronic device 102. In one scenario, the first electronic device is a smart speaker in a user's home, and the user is engaged in a phone conversation on a second electronic device (e.g., the user's smartphone). The electronic device 102 or engagement engine 120 uses a connected device monitoring solution or similar functionality to determine which other devices are connected to the electronic device 102. Such monitoring solutions can generally indicate and share status notifications of a user's engagement with one or more connected devices (e.g., over a shared wireless network). In another implementation, the electronic device 102 or engagement engine 120 determines if other users or people are involved in the detected conversation. The presence of other conversation participants can be determined using speaker diarization techniques or voice signature analysis. In response to the user being on or engaged with another electronic device or other users (e.g., a “yes” or “Y” determination at block 308), the electronic device 102 or engagement engine 120 ignores the audio.

At 310, and in response to the user not being on or engaged with another electronic device (e.g., a “no” or “N” determination at block 308), it is determined whether the user is in the vicinity of the electronic device. By way of example, the electronic device 102 or engagement engine 120 determines if the user speaking is near or proximate to the electronic device 102. In one implementation, the proximity determination is based on the user being within a threshold distance of the electronic device 102. The user's proximity can be determined using sound strength, camera, radar, LiDAR, or similar proximity sensors. In other implementations, the proximity determination is based on whether the user faces the electronic device 102 and/or the distance determination. Cameras or sound strength can determine if the user is facing the electronic device 102. In response to the user not being in the vicinity of the electronic device 102 (e.g., a “no” or “N” determination at block 310), the electronic device 102 or engagement engine 120 ignores the audio.

At 312, and in response to the user being in the vicinity of the electronic device 102 (e.g., a “yes” or “Y” determination at block 310), it is determined whether the captured audio includes sensitive or secret information. By way of example, the engagement engine 120 analyzes for keywords, tones, and/or emotional cues that indicate a sensitive or secret intent for the captured audio. Keywords such as “surprise” or “secret” can indicate that a user does not wish the captured conversation to be acted on by the virtual assistant 116 (e.g., when discussing surprise presents or plans for a significant other). Similarly, sentiment or prosody analysis can analyze the intonation, stress, and rhythm of the captured audio to determine whether the user wishes the captured conversation to be acted on by the virtual assistant 116. In these and similar ways, the engagement engine 120 determines whether the user wishes to have the current conversation ignored or acted upon by the virtual assistant 116. In response to the captured audio, including sensitive or secret information (e.g., a “yes” or “Y” determination at block 312), the electronic device 102 or engagement engine 120 ignores the audio.

At blocks 308 through 312, the engagement engine 120 analyzes the captured audio to determine the user's intent as to whether the user is speaking to the electronic device 102 or intends for the electronic device 102 to listen and act on the user's conversation. For example, the engagement engine 120 can use natural language processing and/or context recognition techniques (e.g., as implemented by one or more machine-learning models) to differentiate between personal-knowledge-base triggering intents (e.g., leading to action by the virtual assistant 116) and irrelevant conversations (e.g., personal discussions with other users). Triggering intents include, for example, commands, questions, or comments directed to or for the virtual assistant 116. In other implementations, the user's intent is determined using fewer or additional determinations than those indicated in blocks 308 through 312. Similarly, the user's intent may be determined using a combination of determinations from the analysis performed at blocks 308 through 312.

At 314, and in response to the captured audio not including sensitive or secret information (e.g., a “no” or “N” determination at block 312), it is determined whether the captured audio includes information or requests relevant to the user's personal knowledge base. By way of example, the engagement engine 120 determines whether to have the electronic device 102 or virtual assistant 116 engage in updating the personal knowledge base 118 (or similarly perform an action corresponding to the detected conversation) or ignore the conversation. Similarly, the engagement engine 120 can use predefined personal preference settings (e.g., “ignore phone conversations” or “do not record private conversations”) to determine whether the captured audio is relevant to the personal knowledge base 118. In response to the captured audio not being relevant to the personal knowledge base (e.g., a “no” or “N” determination at block 314), the electronic device 102 or engagement engine 120 ignores the audio.

At 316, and in response to the captured audio being relevant to the personal knowledge base (e.g., a “yes” or “Y” determination at block 314), it is determined whether the user has confirmed taking action in response to the detected conversation. By way of example, the electronic device 102 or the virtual assistant 116 requests user confirmation about updating the personal knowledge base. If the user does not provide confirmation or declines the action by the virtual assistant 116 (e.g., a “no” or “N” determination at block 316), the electronic device 102 or engagement engine 120 ignores the audio (and the associated action).

In one implementation, the engagement engine 120 completes a feedback loop based on the user's confirmation or lack thereof to enhance a machine-learning model of the engagement engine 120 for future conversations. In this way, the engagement engine 120 can better predict when particular users want to update their associated personal knowledge base or ignore certain conversations. In other implementations, the user confirmation at block 316 is optional or is provided in response to the engagement engine 120 determining that the likelihood that the user wants the virtual assistant to act upon the conversation is below a predetermined threshold value.

At 318, and in response to the user providing confirmation (e.g., a “yes” or “Y” determination at block 316), the electronic device 102 or engagement engine 120 initiates the requested action or update to the personal knowledge base by the virtual assistant 116.

FIG. 4 depicts an example procedure 400 for controlling personal knowledge feeds among listening devices in accordance with one or more implementations. At 402, audio data of a conversation including a user of the electronic device is captured using a microphone. For example, the electronic device 102 includes a smartphone, a mobile phone, a smart watch, a laptop, a computer, a tablet, a smart speaker, a smart home device, or an infotainment system in an automobile.

At 404, the conversation is ignored in response to determining that the user does not intend to utilize a virtual assistant of the electronic device. By way of example, the engagement engine 120 determines that the user does not intend to utilize the virtual assistant 116 by determining that the user is using another electronic device. The use of another device can be determined by monitoring the user's activity on the other electronic device. Similarly, the engagement engine 120 can determine that the conversation can be ignored by determining that the user is speaking with another person, not in proximity of the electronic device 102, or not facing the electronic device 102. In one implementation, engagement engine 120 ignores the conversation using a machine-learning model with natural language processing or context recognition to classify the detected conversation as a personal discussion. For example, the machine-learning model is trained to classify the conversation based on emotional cues, keywords, tone, or speaking volume associated with the conversation.

In response to a determination that the user intends to utilize the virtual assistant 116, the engagement engine 120 causes the virtual assistant 116 to perform an action based on the conversation. For example, the virtual assistant 116 can update the personal knowledge base 118 based on information included in the conversation. Similarly, the virtual assistant 116 can respond to an explicit or implicit request or command. The engagement engine 120 can determine that the user intends to utilize the virtual assistant 116 by determining whether one or more conditions of a predefined user setting or a learned user preference are satisfied by the conversation's context or substance. Prior to performing the action based on the conversation or ignoring the conversation, the virtual assistant 116 prompts the user to confirm the action.

FIG. 5 illustrates various components of an example electronic device that can implement embodiments of the techniques discussed herein. The electronic device 500 can be implemented as any of the devices described with reference to the previous Figures, such as any client device, mobile phone, tablet, computing, communication, entertainment, gaming, media playback, or other electronic device. In one or more embodiments, the electronic device 500 includes the personal knowledge base 118 and engagement engine 120, as described above.

The electronic device 500 includes one or more data input components 502 via which any type of data, media content, or inputs can be received, such as user-selectable inputs, messages, music, television content, recorded video content, and any other type of text, audio, video, or image data received from any content or data source. The data input components 502 may include various data input ports such as universal serial bus ports, coaxial cable ports, and other serial or parallel connectors (including internal connectors) for flash memory, DVDs, compact discs, and the like. These data input ports may be used to couple the electronic device 500 to components, peripherals, or accessories such as keyboards, microphones, or cameras. The data input components 502 may also include various other input components such as microphones, touch sensors, touchscreens, keyboards, and so forth.

The device 500 includes communication transceivers 504 that enable one or both wired and wireless communication of device data with other devices (e.g., associated with a secured area). The device data can include the personal knowledge base 118 or any text, audio, video, image data, or combinations thereof. Example transceivers include wireless personal area network (WPAN) radios compliant with various IEEE 802.15 (Bluetooth™) standards, wireless radios compliant with various IEEE 802.15.4 (Ultra-Wideband™) standards wireless local area network (WLAN) radios compliant with any of the various IEEE 802.11 (WiFiTM) standards, wireless wide area network (WWAN) radios for cellular phone communication, wireless metropolitan area network (WMAN) radios compliant with various IEEE 802.15 (WiMAX™) standards, wired local area network (LAN) Ethernet transceivers for network data communication, and cellular networks (e.g., third-generation networks, fourth-generation networks such as LTE networks, or fifth-generation networks).

The device 500 includes a processing system 506 of one or more processors (e.g., any of microprocessors, controllers, and the like) or a processor and memory system implemented as a system-on-chip (SoC) that processes computer-executable instructions. The processing system 506 may be implemented at least partially in hardware, which can include components of an integrated circuit or on-chip system, an application-specific integrated circuit (ASIC), a field-programmable gate array (FPGA), a complex programmable logic device (CPLD), and other implementations in silicon or other hardware.

Alternately or in addition, the device can be implemented with any one or combination of software, hardware, firmware, or fixed logic circuitry implemented in connection with processing and control circuits, which are generally identified at 508. The device 500 may further include any type of a system bus or other data and command transfer system that couples the various components within the device. A system bus can include any one or combination of different bus structures and architectures, as well as control and data lines.

The device 500 also includes computer-readable storage memory devices 510 that enable one or both of data and instruction storage thereon, such as data storage devices that can be accessed by a computing device, and that provide persistent storage of data and executable instructions (e.g., software applications, programs, functions, and the like). Examples of the computer-readable storage memory devices 510 include volatile memory and non-volatile memory, fixed and removable media devices, and any suitable memory device or electronic data storage that maintains data for computing device access. The computer-readable storage memory can include various implementations of random access memory (RAM), read only memory (ROM), flash memory, and other types of storage media in various memory device configurations. The device 500 may also include a mass storage media device.

The computer-readable storage memory device 510 provides data storage mechanisms to store the device data 512, other types of information or data (e.g., voice signatures 112 and personal knowledge base 118), and various device applications 514 (e.g., software applications). For example, an operating system 516 can be maintained as software instructions with a memory device and executed by the processing system 506 to cause the processing system 506 to perform various acts. The device applications 514 may also include a device manager, such as any form of a control application, software application, signal-processing and control module, code that is native to a particular device, a hardware abstraction layer for a particular device, and so on.

The device 500 can also include one or more device sensors 518, such as any one or more of an ambient light sensor, a proximity sensor, a touch sensor, an infrared (IR) sensor, accelerometer, gyroscope, thermal sensor, audio sensor (e.g., microphone 108), and the like. The device 500 can also include one or more power sources 520, such as when the device 500 is implemented as a mobile device. The power sources 520 may include a charging or power system, and can be implemented as a flexible strip battery, a rechargeable battery, a charged super-capacitor, or any other type of active or passive power source.

The device 500 additionally includes an audio or video processing system 522 that generates one or both of audio data for an audio system 524 and display data for a display system 526. In accordance with some embodiments, the audio/video processing system 522 is configured to receive call audio data from the transceiver 504 and communicate the call audio data to the audio system 524 for playback at the device 500. The audio system or the display system may include any devices that process, display, or otherwise render audio, video, display, or image data. Display data and audio signals can be communicated to an audio component or to a display component, respectively, via an RF (radio frequency) link, S-video link, HDMI (high-definition multimedia interface), composite video link, component video link, DVI (digital video interface), analog audio connection, or other similar communication link. In implementations, the audio system or the display system are integrated components of the example device. Alternatively, the audio system or the display system are external, peripheral components to the example device.

Although implementations of techniques for controlling personal knowledge feeds among listening devices have been described in language specific to features or methods, the subject of the appended claims is not necessarily limited to the specific features or methods described. Rather, the specific features and methods are disclosed as example implementations of techniques for controlling personal knowledge feeds among listening devices. Further, various different examples are described, and it is to be appreciated that each described example can be implemented independently or in connection with one or more other described examples. Additional aspects of the techniques, features, and/or methods discussed herein relate to one or more of the following:
In some aspects, the techniques described herein relate to an electronic device comprising a memory, and one or more processors coupled with the memory and configured to cause the electronic device to capture, via a microphone, audio data of a conversation including a user of the electronic device and, in response to determining that the user does not intend to utilize a virtual assistant of the electronic device, ignore, by the virtual assistant, the conversation.

In some aspects, the techniques described herein relate to an electronic device wherein the one or more processors are configured to cause the electronic device to determine that the user does not intend to utilize the virtual assistant by determining that another electronic device is in use for the conversation.

In some aspects, the techniques described herein relate to an electronic device wherein the one or more processors are configured to cause the electronic device to determine that the user does not intend to utilize the virtual assistant by at least one of determining that the user is not in proximity of the electronic device or determining that the user is not facing the electronic device.

In some aspects, the techniques described herein relate to an electronic device wherein the one or more processors are configured to cause the electronic device to determine that the user does not intend to utilize the virtual assistant by determining that the user is speaking with another person.

In some aspects, the techniques described herein relate to an electronic device wherein the one or more processors are configured to cause the electronic device to determine that the user does not intend to utilize the virtual assistant by determining, using a machine-learning model with natural language processing or context recognition, the conversation is a personal discussion.

In some aspects, the techniques described herein relate to an electronic device wherein the machine-learning model is trained to use one or more of emotional cues, keywords, tone, or speaking volume to classify the conversation.

In some aspects, the techniques described herein relate to an electronic device wherein the machine-learning model is configured to learn based on explicit or implicit feedback by the user to correct or incorrect conversation classifications by the machine-learning model.

In some aspects, the techniques described herein relate to an electronic device wherein the one or more processors are further configured to, in response to determining that the user intends to utilize the virtual assistant, cause the electronic device to perform, using the virtual assistant, an action or update a personal knowledge base associated with the user based on the conversation.

In some aspects, the techniques described herein relate to an electronic device wherein the one or more processors are configured to cause the electronic device to determine that the user intends to utilize the virtual assistant by determining one or more conditions of a predefined user setting or a learned user preference are satisfied by the conversation.

In some aspects, the techniques described herein relate to an electronic device wherein the one or more processors are configured to, prior to performing the action based on the conversation, cause the electronic device to prompt the user to accept the action by the virtual assistant.

In some aspects, the techniques described herein relate to an electronic device wherein the electronic device comprises one or more of a smartphone, a mobile phone, a smart watch, a laptop, a computer, a tablet, a smart speaker, a smart home device, or an infotainment system in an automobile.

In some aspects, the techniques described herein relate to a method comprising capturing, via a microphone of an electronic device, audio data of a conversation that includes a user of the electronic device and, in response to determining that the user does not intend to utilize a virtual assistant of the electronic device, ignoring, by the virtual assistant, the conversation.

In some aspects, the techniques described herein relate to a method wherein determining that the user does not intend to utilize the virtual assistant comprises determining that another electronic device is in use for the conversation.

In some aspects, the techniques described herein relate to a method wherein determining that the user does not intend to utilize the virtual assistant comprises at least one of determining that the user is not in proximity of the electronic device or determining that the user is not facing the electronic device.

In some aspects, the techniques described herein relate to a method wherein determining that the user does not intend to utilize the virtual assistant comprises determining that the user is speaking with another person.

In some aspects, the techniques described herein relate to a method wherein determining that the user does not intend to utilize the virtual assistant comprises determining, using a machine-learning model with natural language processing or context recognition, the conversation is a personal discussion, the machine-learning model being trained to use one or more of emotional cues, keywords, tone, or speaking volume to classify the conversation.

In some aspects, the techniques described herein relate to a method wherein the machine-learning model is configured to learn based on explicit or implicit feedback by the user to correct or incorrect conversation classifications by the machine-learning model.

In some aspects, the techniques described herein relate to a method wherein the method further comprises, in response to determining that the user intends to utilize the virtual assistant, prompting the user to accept an action or update of a personal knowledge base associated with the user by the virtual assistant based on the conversation and, in response to receiving acceptance, performing, by the virtual assistant, the action or the update of the personal knowledge base based on the conversation.

In some aspects, the techniques described herein relate to a method wherein determining that the user intends to utilize the virtual assistant comprises determining one or more conditions of a predefined user setting or a learned user preference are satisfied by the conversation.

In some aspects, the techniques described herein relate to a system comprising a microphone configured to capture audio data of a conversation within audio detection range of the microphone and a virtual assistant configured to ignore the conversation based on a determination that the virtual assistant is not intended to be utilized to capture and process the conversation.

1. An electronic device comprising:
a memory; and
one or more processors coupled with the memory and configured to cause the electronic device to:
capture, via a microphone, audio data of a conversation including a user of the electronic device; and
in response to determining that the user does not intend to utilize a virtual assistant of the electronic device, ignore, by the virtual assistant, the conversation.

2. The electronic device of claim 1, wherein the one or more processors are configured to cause the electronic device determine that the user does not intend to utilize the virtual assistant by determining that another electronic device is in use for the conversation.

3. The electronic device of claim 2, wherein the one or more processors are further configured to cause the electronic device to determine that the user does not intend to utilize the virtual assistant by at least one of:
determining that the user is not in proximity of the electronic device; or
determining that the user is not facing the electronic device.

4. The electronic device of claim 2, wherein the one or more processors are further configured to cause the electronic device to determine that the user does not intend to utilize the virtual assistant by determining that the user is speaking with another person.

5. The electronic device of claim 2, wherein the one or more processors are configured to cause the electronic device to determine that the user does not intend to utilize the virtual assistant by determining, using a machine-learning model with natural language processing or context recognition, the conversation is a personal discussion.

6. The electronic device of claim 5, wherein the machine-learning model is trained to use one or more of emotional cues, keywords, tone, or speaking volume to classify the conversation.

7. The electronic device of claim 5, wherein the machine-learning model is configured to learn based on explicit or implicit feedback by the user to correct or incorrect conversation classifications by the machine-learning model.

8. The electronic device of claim 1, wherein the one or more processors are further configured to, in response to determining that the user intends to utilize the virtual assistant, cause the electronic device to perform, using the virtual assistant, an action or update a personal knowledge base associated with the user based on the conversation.

9. The electronic device of claim 8, wherein the one or more processors are configured to cause the electronic device to determine that the user intends to utilize the virtual assistant by determining one or more conditions of a predefined user setting or a learned user preference are satisfied by the conversation.

10. The electronic device of claim 8, wherein the one or more processors are configured to, prior to performing the action based on the conversation, cause the electronic device to prompt the user to accept the action by the virtual assistant.

11. The electronic device of claim 1, wherein the electronic device comprises one or more of a smartphone, a mobile phone, a smart watch, a laptop, a computer, a tablet, a smart speaker, a smart home device, or an infotainment system in an automobile.

12. A method comprising:
capturing, via a microphone of an electronic device, audio data of a conversation that includes a user of the electronic device; and
in response to determining that the user does not intend to utilize a virtual assistant of the electronic device, ignoring, by the virtual assistant, the conversation.

13. The method of claim 12, wherein determining that the user does not intend to utilize the virtual assistant comprises determining that another electronic device is in use for the conversation.

14. The method of claim 13, wherein determining that the user does not intend to utilize the virtual assistant comprises at least one of:
determining that the user is not in proximity of the electronic device; or
determining that the user is not facing the electronic device.

15. The method of claim 13, wherein determining that the user does not intend to utilize the virtual assistant comprises determining that the user is speaking with another person.

16. The method of claim 13, wherein determining that the user does not intend to utilize the virtual assistant comprises determining, using a machine-learning model with natural language processing or context recognition, the conversation is a personal discussion, the machine-learning model being trained to use one or more of emotional cues, keywords, tone, or speaking volume to classify the conversation.

17. The method of claim 16, wherein the machine-learning model is configured to learn based on explicit or implicit feedback by the user to correct or incorrect conversation classifications by the machine-learning model.

18. The method of claim 12, wherein the method further comprises:
in response to determining that the user intends to utilize the virtual assistant, prompting the user to accept an action or update of a personal knowledge base associated with the user by the virtual assistant based on the conversation; and
in response to receiving acceptance, performing, by the virtual assistant, the action or the update of the personal knowledge base based on the conversation.

19. The method of claim 18, wherein determining that the user intends to utilize the virtual assistant comprises determining one or more conditions of a predefined user setting or a learned user preference are satisfied by the conversation.

20. A system comprising:
a microphone configured to capture audio data of a conversation within audio detection range of the microphone; and
a virtual assistant configured to ignore the conversation based on a determination that the virtual assistant is not intended to be utilized to capture and process the conversation.
